(19) United States
(12) Patent Application Publication
(10) Pub. No.: US 2025/0151955 A1
(43) Pub. Date: May 15, 2025

(54) Temperature Controlled Charcoal Grill and Smoker

(71) Applicant: Premier Specialty Brands, LLC, Chamblee, GA (US)

(72) Inventors: Daniel Mercer, Hamilton, GA (US); Caitlin McNulty, Columbus, GA (US); William A. Hardy, Phenix City, AL (US); John Darin McLemore, Hamilton, GA (US)

(73) Assignee: Premier Specialty Brands, LLC, Chamblee, GA (US)

(21) Appl. No.: 19/023,855

(22) Filed: Jan. 16, 2025

Related U.S. Application Data
(63) Continuation-in-part of application No. 17/476,188, filed on Sep. 15, 2021, now Pat. No. 12,226,050.
(60) Provisional application No. 63/078,625, filed on Sep. 15, 2020.

(51) Int. Cl. A47J 37/07; A23B 4/052; A47J 36/32; F23N 3/08; F24B 5/02

(52) U.S. Cl. CPC A47J 37/0754; A23B 4/0523; A47J 36/321; A47J 37/0704; A47J 37/0786; F23N 3/082; F24B 5/023; F23N 2233/08; F23N 2241/08

(57) ABSTRACT

The disclosed embodiments provide a temperature controlled charcoal grill and smoker that enables users to better control the cooking and smoking temperature relative to previous solutions. In some embodiments, for example, a user may place a divider in the interior of a fuel basket to coarsely adjust the amount and type of solid fuel used to heat a food-cooking enclosure of the temperature controlled charcoal grill and smoker. In addition, the user can also position a heat deflector tent above one or more heat transfer openings in a grease tray to further adjust the cooking and smoking temperature. Further still, the user can provide even finer control (including closed-loop control) over the cooking and smoking temperature using a controller that controls the speed of a fan that directs combustion air into the fuel basket.

### CROSS REFERENCE TO RELATED APPLICATION

The present application is a continuation-in-part of U.S. application Ser. No. 17/476,188 filed Sep. 15, 2021, and titled “Temperature Controlled Charcoal Grill and Smoker,” which claims the benefit of priority under 35 U.S.C. § 119(e) to U.S. Provisional Application No. 63/078,625, entitled “Temperature Controlled Charcoal Grill and Smoker,” filed Sep. 15, 2020, each of which are hereby incorporated by reference in their entirety as if fully set forth herein.

### FIELD OF THE INVENTION

The present invention generally relates to grills and smokers, and more particularly, to grills and smokers that provide users with improved temperature control for cooking and smoking food within their cooking enclosures.

### BACKGROUND OF THE INVENTION

Traditional grills and smokers use a solid fuel, such as charcoal, lump coal, or wood pellets positioned inside the food-cooking enclosure. Such grills and smokers typically control the temperature inside the food-cooking enclosure by means of a user's manual adjustments of vents and/or dampers on the grills and smokers.

The cooking and smoking temperature inside the cooking enclosure can be highly sensitive relative to the sizes of the vent openings selected by the user, often requiring trial and error (with feedback from an internal thermometer) to adjust the openings to achieve a desired internal temperature. In addition, the temperature within the cooking chamber is also highly dependent on the amount and distribution of the charcoal or wood fuel positioned in the grill or smoker. Managing both the fuel burning and air flow within the cooking enclosure can be a difficult process for inexperienced users trying to control the cooking or smoking temperature.

Temperature control in vertical grills and smokers can be especially difficult. The cooking enclosure of a vertical grill or smoker typically comprises multiple cooking racks and one or more hooks on which various different types of food products can be loaded. By stacking food onto the cooking racks and hooks, vertical grills and smokers can be used to cook or smoke more food products at the same time as compared with conventional grills and smokers with only a horizontal cooking surface. Vertical grills and smokers are also more space efficient, since they generally have a smaller footprint and require less space on a deck or patio. In operation, fuel combusts at the bottom of the vertical grill and smoker, and the generated heat and/or smoke rises over a relatively large distance to an exhaust opening near the top of the cooking enclosure. It can be difficult for users of such grills and smokers to control or avoid a temperature gradient between the bottom and top of the vertical cooking enclosure. This can result in food products on different cooking racks and hooks being exposed to inconsistent and/or uneven temperatures.

There is therefore a need in the art for improved grills and smokers, including vertical grills and smokers, that would allow users to more easily control the temperature of the cooking enclosure when operating the grill or smoker.

### SUMMARY OF THE INVENTION

The disclosed embodiments provide a temperature controlled charcoal grill and smoker that enables users to better control the cooking and smoking temperature relative to previous solutions. In the disclosed embodiments, the temperature controlled charcoal grill and smoker has a cabinet with an upper food-cooking enclosure and a lower fuel enclosure. The upper food-cooking enclosure may comprise cooking racks and/or hooks for use as a vertical grill and smoker. A grease tray with one or more heat transfer openings separates the upper food-cooking enclosure from the lower fuel enclosure in the cabinet. The heat transfer opening(s) allow smoke and heat to enter the upper food-cooking enclosure from the fuel enclosure below.

In the exemplary embodiments, a top door on the front of the cabinet may provide a user with access to the interior of the upper food-cooking enclosure. The upper food-cooking enclosure may comprise vertically spaced grill racks, a water pan, and at least one temperature sensor. An exhaust opening in the back of the cabinet, near the top of the cabinet, allows smoke and heat to escape from the upper food-cooking enclosure as fresh smoke and hot air enters the upper food-cooking enclosure through the heat transfer openings in the grease tray.

A bottom door on the front of the cabinet may provide a user with access to the interior of the lower fuel enclosure. The fuel enclosure includes a fuel grate in the form of a basket with an open top and holes on each of its side walls and bottom surface. Thus, the fuel grate equivalently may be referred to herein as a fuel basket. In some embodiments, the fuel grate is substantially shaped as a rectangular basket. A user may remove the fuel basket, load it with a solid fuel, such as lump charcoal or charcoal briquettes, and then insert the loaded fuel basket back into the lower fuel enclosure through the bottom door. In some embodiments, the fuel basket may be nested inside an ash bowl that catches the ashes from the solid fuel, such as charcoal, as it burns in the fuel basket. The ash bowl with the nested fuel basket may be removed as a single unit through the bottom door of the lower fuel enclosure. For example, the ash bowl with the nested fuel basket may be positioned on a removable tray in the lower fuel enclosure.

In some embodiments, a user may place a hollow divider into the interior of the fuel basket before adding the solid fuel. The divider is configured to partition the interior of the fuel basket into at least two sections where solid fuel may be placed in the basket. In one mode of operation, wood chunks to add smoke flavor may be placed inside at least one interior section of the hollow divider and charcoal may be placed outside of the divider in the fuel basket. In certain embodiments, the divider is substantially rectangular shaped, whereby the user may place solid fuel (such as wood) in the center of the rectangular divider and other solid fuel (such as charcoal) may be positioned outside of the divider in the fuel basket. The divider may have a pair of substantially parallel solid sides configured to generally extend along the direction of the length of the fuel basket, another pair of solid sides that form closed ends of the divider, an open bottom, and an open top. Those skilled in the art will appreciate that other divider shapes are possible, for example, using any closed or open polygon shapes, so long as solid fuel may be placed within one or more interior sections of the divider and also outside of the divider after the user has positioned the divider inside the fuel basket.

Insertion of the hollow divider into the fuel basket may allow for rough adjustment of the cooking or smoking temperature, for example by limiting an amount of solid fuel that may be placed in the fuel basket. In some embodiments, up to 16 pounds of charcoal briquettes may be loaded into the fuel basket to achieve cooking and smoking temperatures above 275 degrees Fahrenheit in the food-cooking enclosure. For cooking temperatures below 275 degrees Fahrenheit, up to 12 pounds of charcoal briquettes may be loaded into the fuel basket. Besides controlling the amount of solid fuel in the fuel basket, with or without using the divider, the user can further control the temperature inside the food-cooking enclosure by selectively covering and uncovering the heat transfer openings in the grease tray and/or using a controller to select an appropriate speed of a fan as discussed below.

For example, to control the temperature within the upper food-cooking enclosure, combustion air from a fan may be directed into the fuel basket. The output of the fan may be connected to an air duct or manifold, which in some embodiments, directs the fan's air flow into an air column having an outlet in close proximity to the fuel basket. In some embodiments, the outlet may include one or more air deflectors configured to channel the air flow from the fan directly into the fuel basket during combustion of the solid fuel. The air column may be located within the lower fuel enclosure and adjacent to one side of the fuel basket.

In addition, the user also may control the temperature within the food-cooking enclosure by placing a heat deflector tent over the heat transfer openings in the grease tray. In some embodiments, the heat deflector tent may be generally shaped like a table having a substantially flat surface and a set of legs for supporting the surface. For cooking or smoking at high temperatures, the heat deflector tent may be mounted on the grease tray with its legs extending downwards toward the grease tray so that the heat tent's flat surface is elevated above the heat transfer openings. Alternatively, for cooking or smoking at lower temperatures, the heat deflector tent may be mounted on the grease tray in an upside-down orientation such that its substantially flat surface may directly contact the grease tray and covers at least a portion of the heat transfer openings. In this latter configuration, the heat deflector tent allows less heat and/or smoke to pass through the heat transfer openings into the food-cooking enclosure.

In accordance with the disclosed embodiments, the temperature in the food-cooking enclosure also may be adjusted by controlling a fan configured to blow combustion air into the fuel basket. For example, a controller coupled to the grill and smoker may be configured to receive a cooking temperature input from the user, monitor the temperature in the food-cooking enclosure by means of at least one temperature sensor, and control a speed of the fan to thereby control the amount of combustion air forced into the fuel basket. The fan also may be interlocked with the top and/or bottom doors so the fan is turned off if the door has been opened. At the end of the cooking or smoking process, the user may use the controller to turn up the temperature in the food-cooking enclosure (e.g., by increasing the fan speed) to allow the solid fuel to burn out in the fuel basket.

The controller may be a hardware module or other control unit that is either permanently or removably attached to the grill and smoker. The controller may comprise a control panel with one or more user-interface elements, such as hardware and/or software components, that allow a user to select a desired cooking or smoking temperature. In some embodiments, the controller may include a display unit, which may comprise a touch screen. In accordance with the disclosed embodiments, the control panel can be integrated with the controller or otherwise coupled to the controller. In some embodiments, the controller may comprise an oil capillary tube that controls an electronic switch configured to turn on and off the fan. For example, the oil capillary tube may be positioned within the grill and smoker and may be configured to close the electronic switch, thus turning on the fan, when the temperature in the grill and smoker is below a certain threshold temperature. Similarly, the oil capillary tube may be configured to open the electronic switch, turning off the fan, when the temperature in the grill and smoker exceeds the threshold temperature. The controller could also comprise or control other types of electronic switches, relays, or other controllers for turning on and off the fan.

The controller may be configured to communicate with one or more remote devices (such as phones, tablets, laptops, desktops, wearable devices, or any other user devices) over wireless connections. In such embodiments, the user may input information to send to the controller using an application executing on a mobile device. The mobile device may transmit this user-inputted information to the control unit over a direct wireless link (such as using Bluetooth or another peer-to-peer wireless protocol) or, alternatively, through a wireless network (such as an 802.11 wireless network) to which both the controller and mobile device are connected. The controller may be configured to transmit information back to the mobile device for display to the user. In some embodiments, the controller unit also may be configured to communicate information over a wireless network to one or more remote computers, for example, in a cloud-computing platform. For example, the controller may transmit information about the grill and smoker to a cloud service and/or receive recommendations or instructions from the cloud service, for instance, about how to optimize control of the fan speed for precisely controlling the temperature inside food-cooking enclosure.

Advantageously, the temperature controlled grill and smoker in the disclosed embodiments provides a multifaceted solution for controlling the cooking and smoking temperature in a food-cooking enclosure, for example, in vertical grills and smokers. As noted above, a user may place a divider in the fuel basket to coarsely adjust the amount and type of solid fuel used to heat the food-cooking enclosure. In addition, the user can also position the heat tent above the one or more heat transfer openings in the grease tray to further adjust the cooking and smoking temperature. Further still, the user can provide finer control (including closed-loop control) over the cooking and smoking temperature using a controller that controls the speed of a fan that directs combustion air into the fuel basket.

The present disclosure is merely exemplary of certain embodiments of the present invention. Further objects, features, and advantages will become apparent upon consideration of the following detailed description of the exemplary embodiments when taken in conjunction with the drawings and the appended claims.

### BRIEF DESCRIPTION OF THE DRAWINGS

The particular features and advantages of the invention will become apparent from the following description taken in connection with the accompanying drawings in which like reference numbers indicate identical or functionally similar elements. The following figures depict details of disclosed embodiments. The invention is not limited to the precise arrangement shown in these figures, as the accompanying drawings are provided merely as examples:

FIG. 1 is a front perspective view of a temperature controlled charcoal grill and smoker in accordance with certain exemplary embodiments of the present invention.

FIG. 2 is a front elevation view of the temperature controlled charcoal grill and smoker in accordance with certain exemplary embodiments of the present invention.

FIG. 3 is a right side elevation view of the temperature controlled charcoal grill and smoker in accordance with certain exemplary embodiments of the present invention.

FIG. 4 is a back elevation view of the temperature controlled charcoal grill and smoker in accordance with certain exemplary embodiments of the present invention.

FIG. 5 is a left side elevation view of the temperature controlled charcoal grill and smoker in accordance with certain exemplary embodiments of the present invention.

FIG. 6 is a top plan view of the temperature controlled charcoal grill and smoker in accordance with certain exemplary embodiments of the present invention.

FIG. 7 is a bottom plan view of the temperature controlled charcoal grill and smoker in accordance with certain exemplary embodiments of the present invention.

FIG. 8 is a front elevation view of the temperature controlled charcoal grill and smoker with the doors removed to show internal details in accordance with the present invention.

FIG. 9 is a front elevation view of the temperature controlled charcoal grill and smoker with the doors and front panel removed to show internal details in accordance with certain exemplary embodiments of the present invention.

FIG. 10 is a front perspective view of the temperature controlled charcoal grill and smoker with the doors and control panel removed to show internal details in accordance with certain exemplary embodiments of the present invention.

FIG. 11 is an enlarged front perspective view of the temperature controlled charcoal grill and smoker with the doors and control panel removed to show internal details in accordance with certain exemplary embodiments of the present invention.

FIG. 12 is a top plan view of the of the temperature controlled charcoal grill and smoker with the top, grill racks, water pan rack, and water pan removed to show internal details in accordance with certain exemplary embodiments of the present invention.

FIG. 13A is an enlarged front perspective view of the grease tray with the heat deflector in its upright position in accordance with certain exemplary embodiments of the present invention.

FIG. 13B is an enlarged front perspective view of the grease tray with the heat deflector in its inverted position in accordance with certain exemplary embodiments of the present invention.

FIG. 14 is an enlarged front perspective view of the temperature controlled charcoal grill and smoker with the doors, control panel, grill racks, water pan rack, water pan, and grease tray removed to show internal details in accordance with certain exemplary embodiments of the present invention.

FIG. 15 is an enlarged front perspective view of the temperature controlled charcoal grill and smoker with the doors, control panel, grill racks, water pan rack, water pan, grease tray, and right side removed to show internal details in accordance with certain exemplary embodiments of the present invention.

FIG. 16 is an enlarged front perspective view of the temperature controlled charcoal grill and smoker with the doors, control panel, grill racks, water pan rack, water pan, grease tray, and right side removed to show internal details in accordance with certain exemplary embodiments of the present invention.

FIG. 17 is a schematic diagram illustrating an exemplary network architecture in which the temperature controlled charcoal grill and smoker may be configured to wirelessly communicate with a user device and also wirelessly communicate via a network with one or more remote computers, for example that provide a cloud service in a cloud computing platform, in accordance with certain exemplary embodiments of the present invention.

FIG. 18A is a perspective view of another embodiment of a temperature controlled charcoal grill and smoker and illustrating line 19B, in accordance with certain exemplary embodiments of the present invention.

FIG. 18B is a perspective view of the other side of the temperature controlled charcoal grill and smoker of FIG. 18A, in accordance with certain exemplary embodiments of the present invention.

FIG. 19A is an exploded view of the inside features of the temperature controlled charcoal grill and smoker of FIGS. 18A and 18B, in accordance with certain exemplary embodiments of the present invention.

FIG. 19B is a cross-sectional view showing the inside features of the food-cooking enclosure of the temperature controlled charcoal grill and smoker of FIGS. 18A-18B which is created by drawing a vertical plane through line 19B, in accordance with certain exemplary embodiments of the present invention.

FIG. 20A is a perspective view of an exemplary heat deflector tent removed from the temperature controlled charcoal grill and smoker, in accordance with certain exemplary embodiments of the present invention.

FIG. 20B is another view of the exemplary heat deflector tent of FIG. 20A, in accordance with certain exemplary embodiments of the present invention.

FIG. 21 is a perspective view of an exemplary grease tray removed from the temperature controlled charcoal grill and smoker, in accordance with certain exemplary embodiments of the present invention.

FIG. 22 is a perspective view of an exemplary fuel basket, in accordance with certain exemplary embodiments of the present invention.

FIG. 23 is a top view of the inside features of temperature controlled charcoal grill and smoker of FIG. 19A showing an exemplary heat deflector tent and grease pan, in accordance with certain exemplary embodiments of the present invention.

### DETAILED DESCRIPTION OF THE DISCLOSED EMBODIMENTS

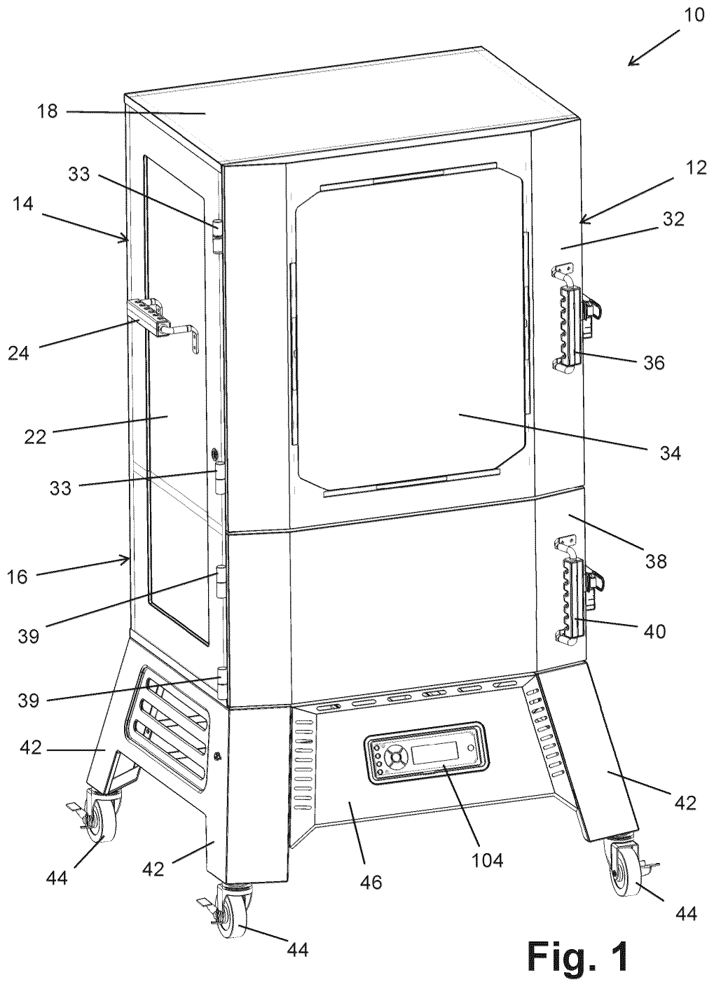

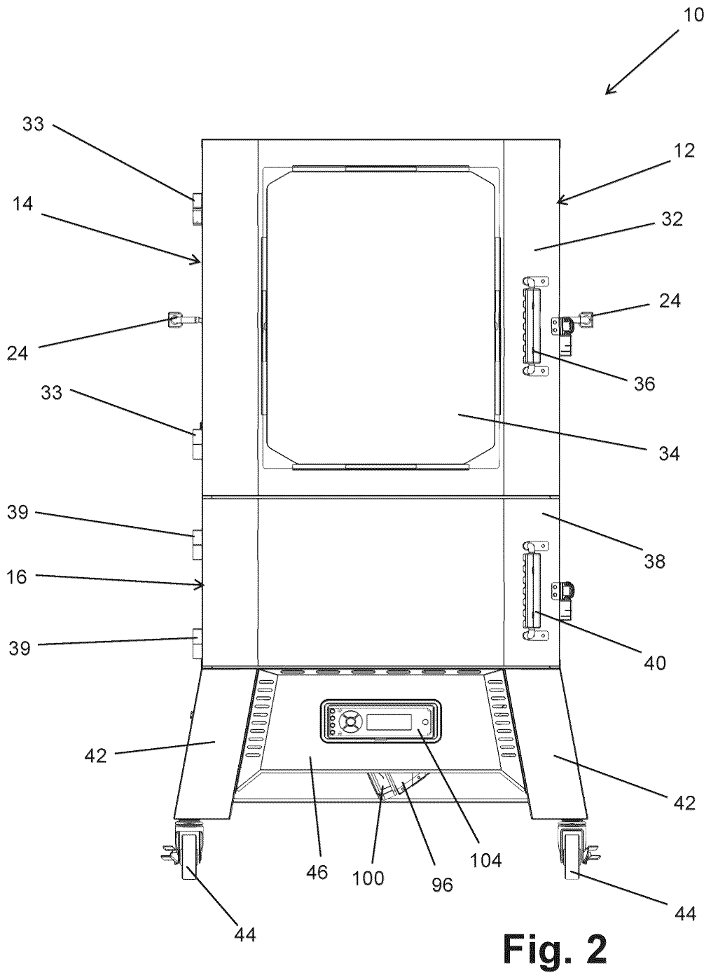

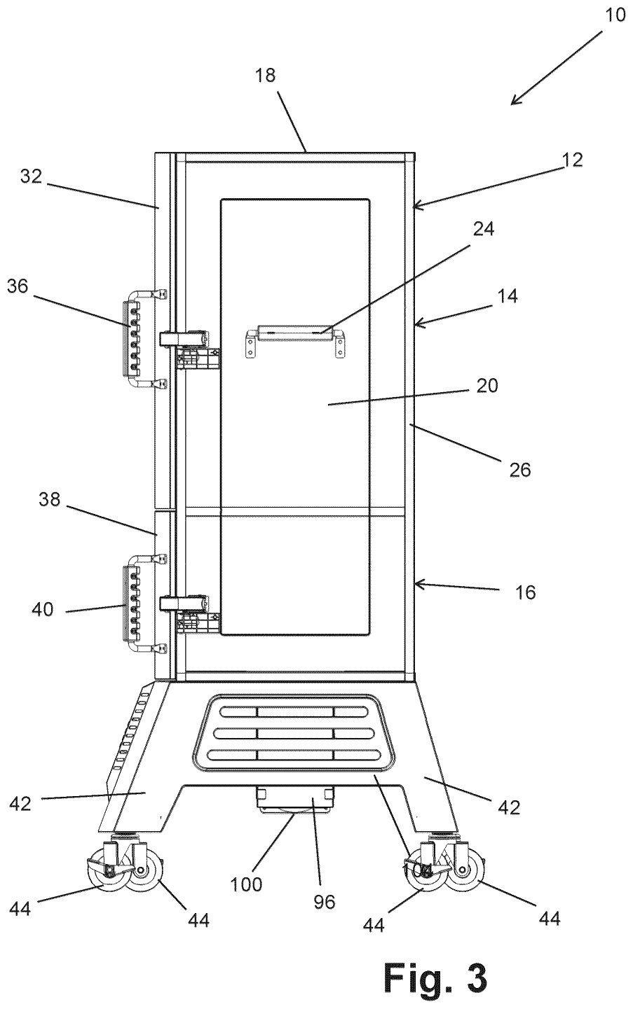

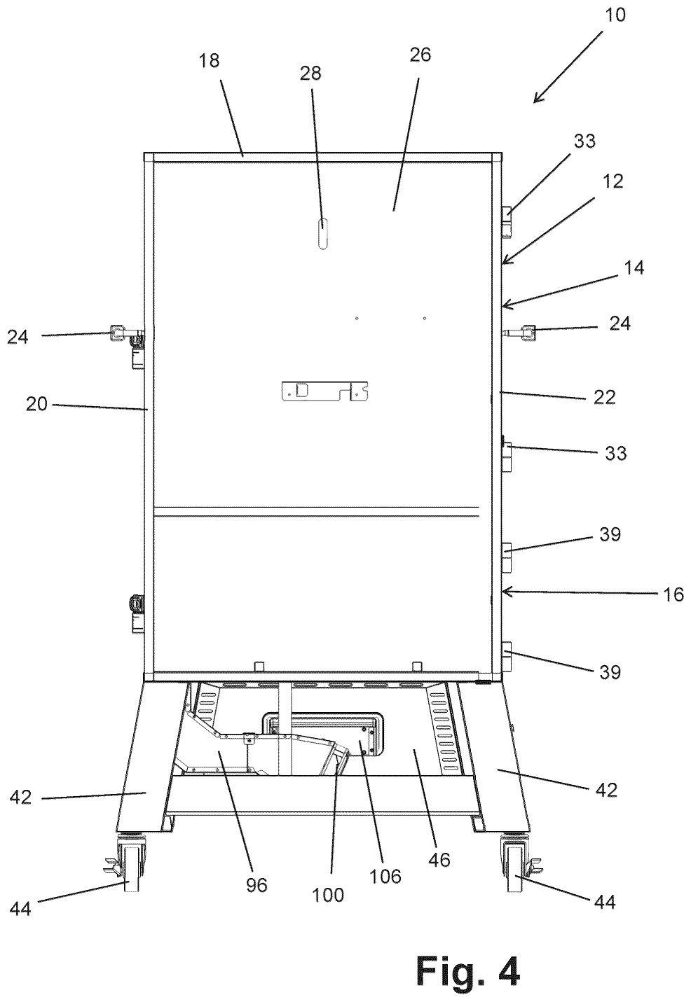

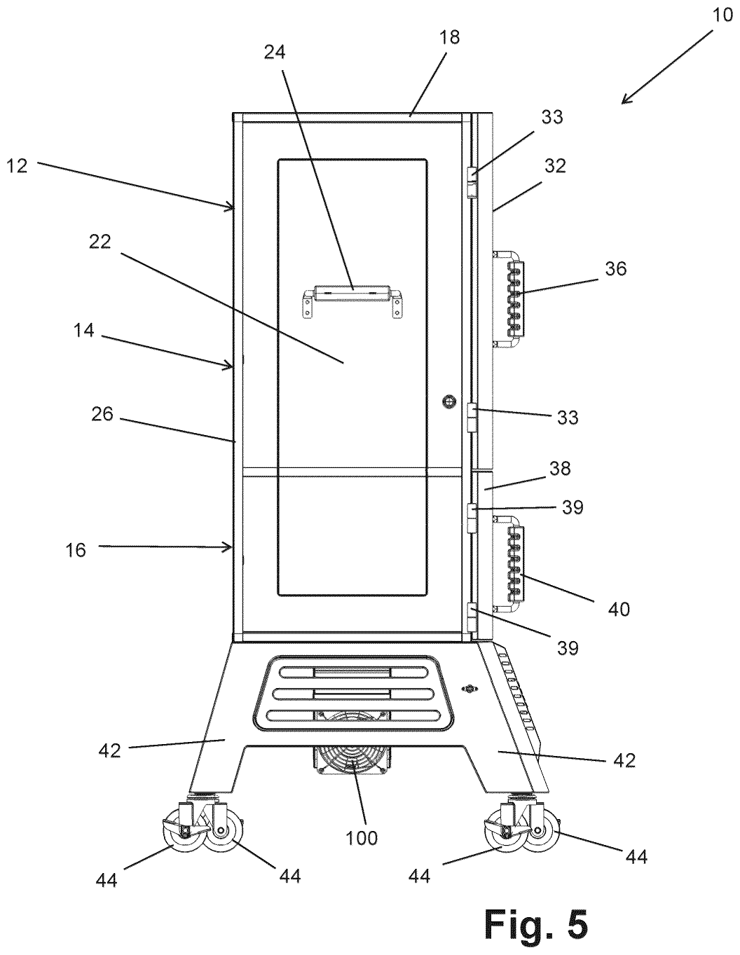

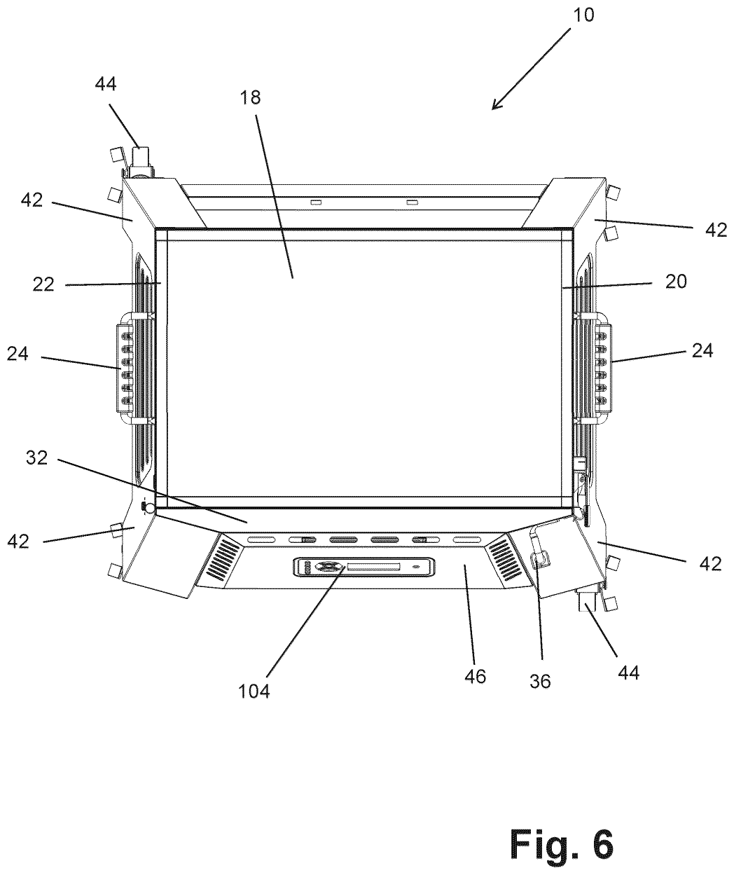

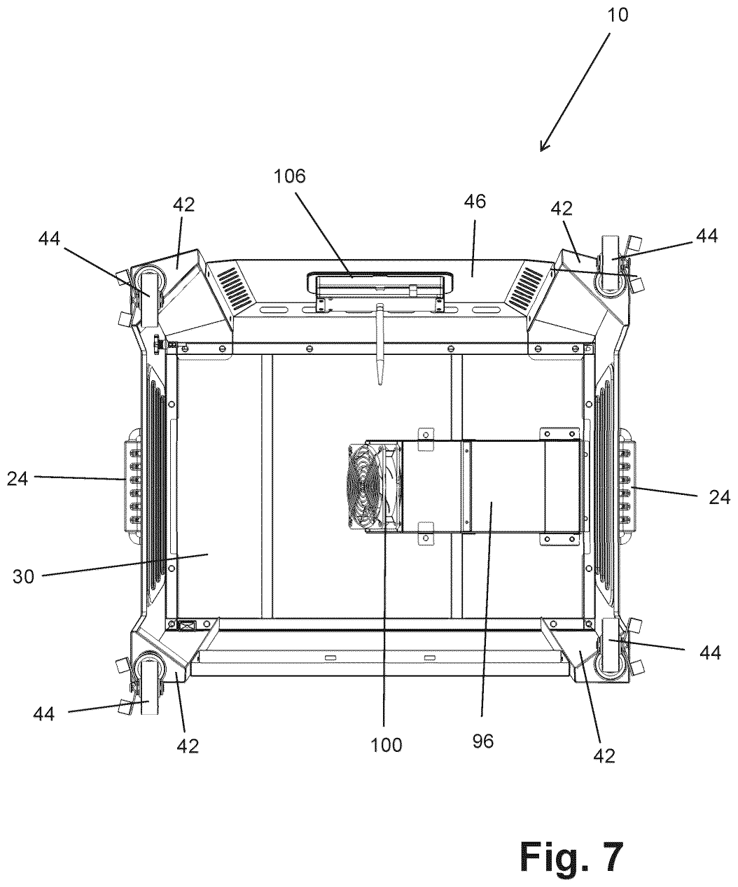

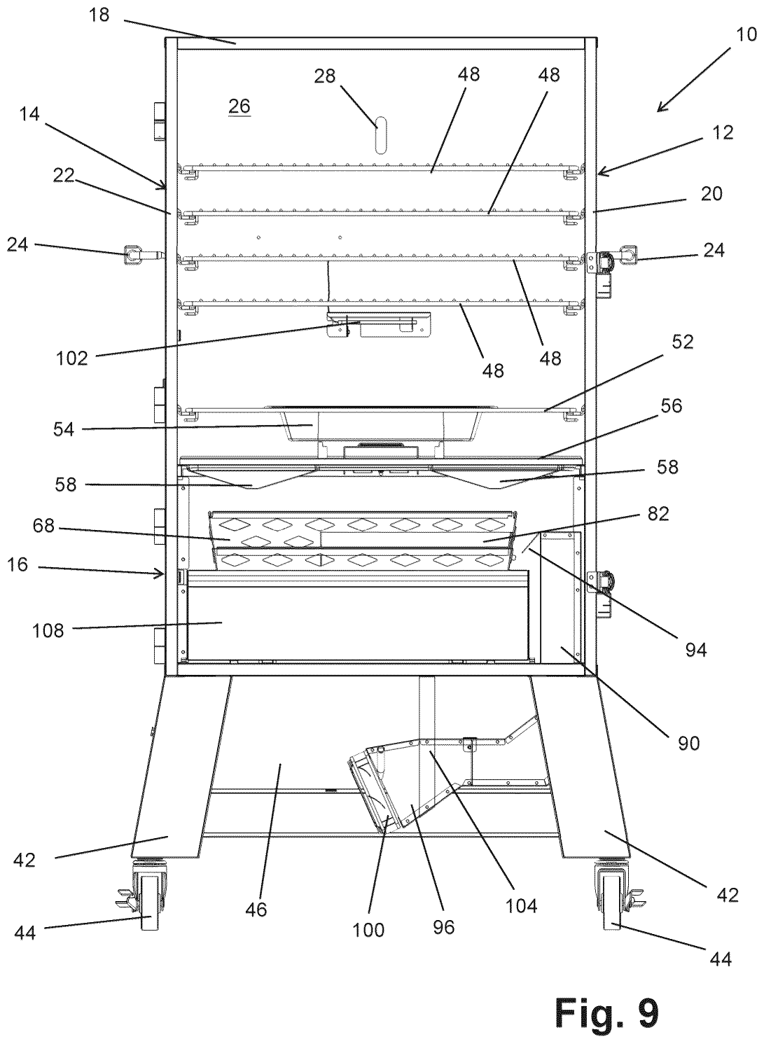

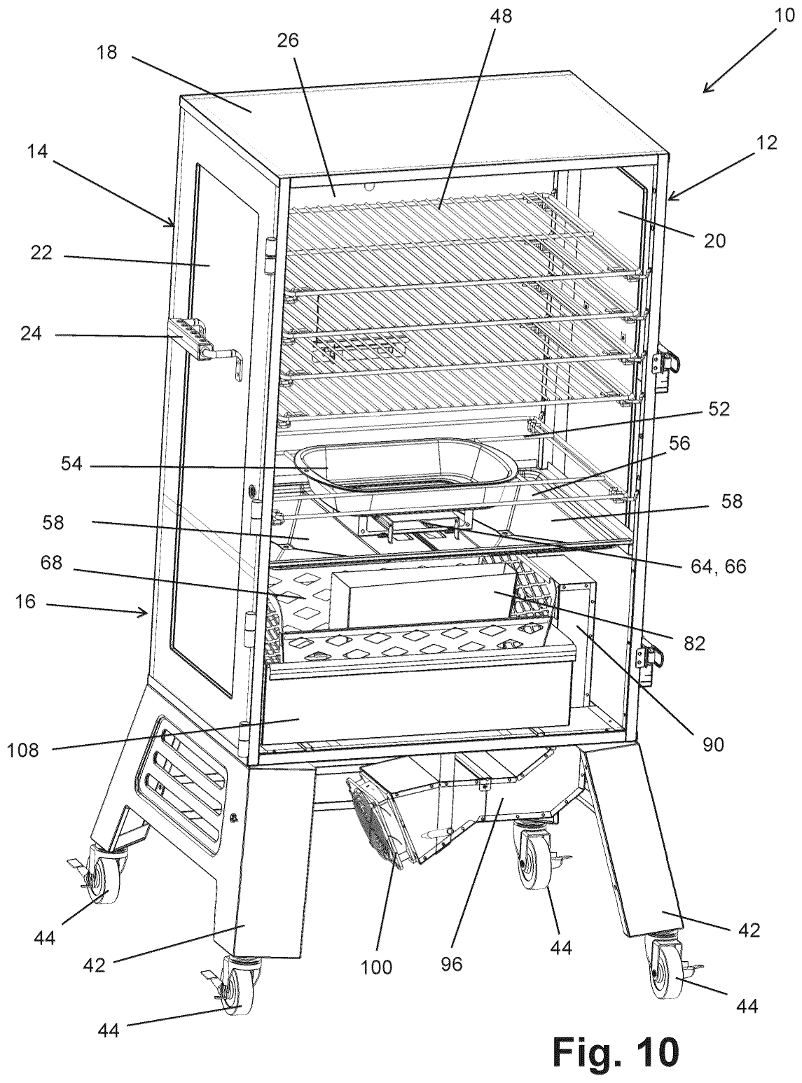

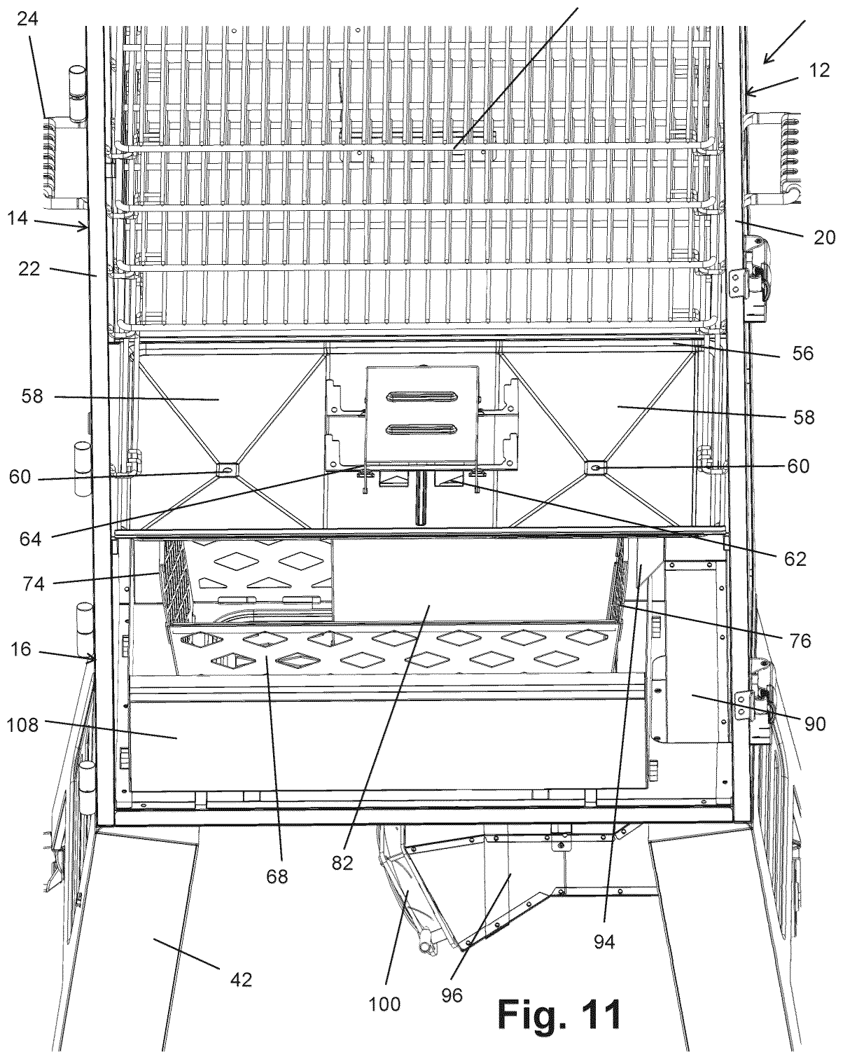

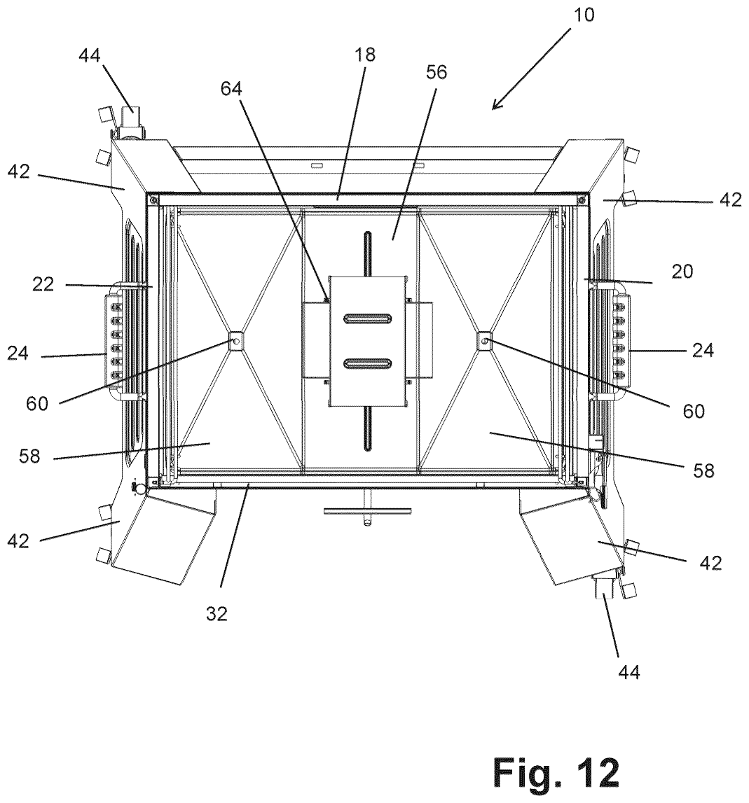

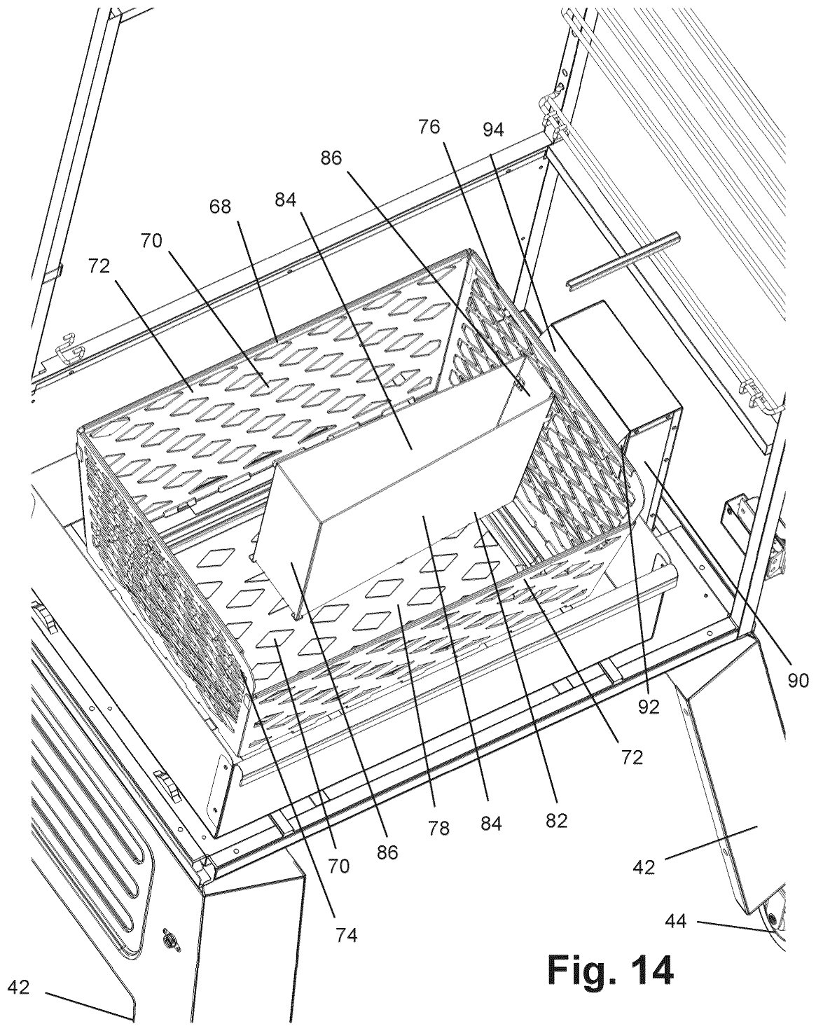

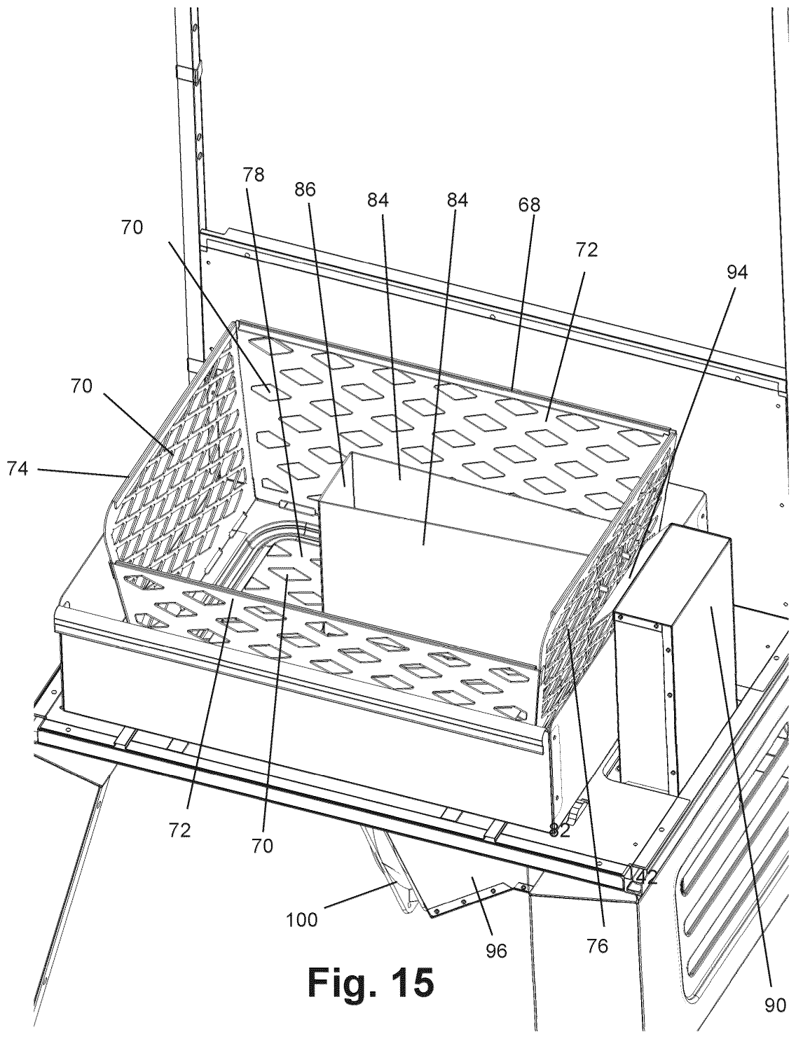

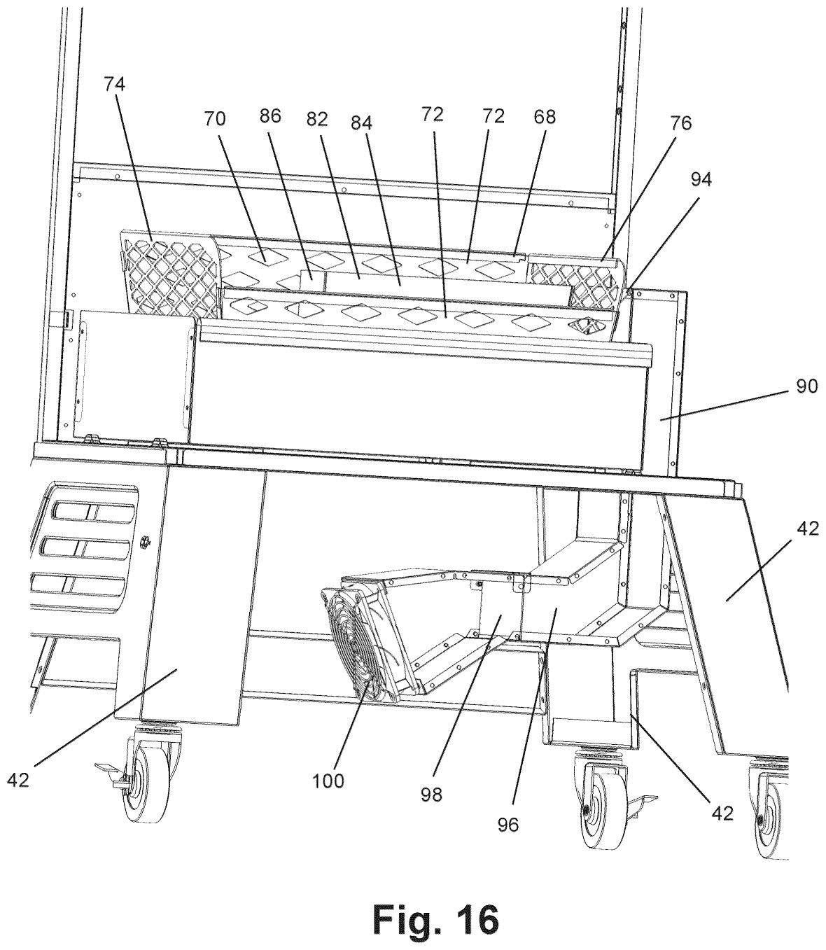

FIGS. 1-16 show various views of a first embodiment of exemplary grill and smoker, such as a vertical grill and smoker, that may be used in accordance with the disclosed embodiments of the invention. In this disclosed embodiment, a temperature controlled charcoal grill and smoker 10 has a cabinet 12 with an upper food-cooking enclosure 14 and a lower fuel enclosure 16. A grease tray 56 with heat transfer openings 62 separates the upper food-cooking enclosure 14 from the lower fuel enclosure 16. The heat transfer openings 62 allow smoke and heat to enter the upper food-cooking enclosure 14 from the lower fuel enclosure 16 below.

The cabinet 12 includes a top 18, a bottom 30, a right side 20, a left side 22, and a back 26. The cabinet 12 is supported on legs 42. The legs 42 may optionally have wheels 44 as illustrated in FIG. 1. Handles 24 are attached to the right side 28 and the left side 22 so that the user can move the grill and smoker 10 on the wheels 44.

In this exemplary embodiment, a top door 32 mounted on hinges 33 with a handle 36 provides access to the upper food-cooking enclosure 14. The top door 32 has a window 34 so that the user can view the food in the upper food-cooking enclosure 14 without opening the top door 32. The upper food-cooking enclosure 14 includes, for instance, vertically spaced grill racks 48, a water pan 54 supported on a water pan rack 52, and at least one temperature sensor 102. One or more exhaust openings 28 in the back 26 of the cabinet 12 near the top 18 of the cabinet 12 allow smoke and heat to escape from the upper food-cooking enclosure 14 as fresh smoke and heat enters the food-cooking enclosure 14 through the heat transfer openings 62 in the grease tray 56.

Further to this exemplary embodiment, a bottom door 38 mounted on hinges 39 with a handle 40 on the front of the cabinet provides access to the lower fuel enclosure 16. The lower fuel enclosure 16 includes a solid-fuel grate 68 (e.g., charcoal grate) in the form of a rectangular basket with an open top and holes 70 on each of its sides 72, left end 74, right end 76, and bottom 78. Those skilled in the art will appreciate that various patterns and arrangements of holes 70 may be used on the sides and bottom of the fuel basket 68; for example, any of the sides 72, left end 74, right end 76, and bottom 78 may employ the same or different arrangements of holes relative to the other surfaces of the fuel basket. In the disclosed embodiment, the sides 72 and the bottom 78 may be formed of metal plates with stamped holes 70. The ends 74 and 76 may be formed of expanded metal. The grate holes 70 result in the fuel basket 68 having sufficient open space to permit ash generated by the combustion of solid fuel to pass from inside of the fuel basket 68 into a surrounding ash bowl 108. In some embodiments, for example, the grate holes 70 may result in the fuel basket 68 having around 34% open space taking into account the holes in all of its side and bottom surfaces. The percentage of open space in the fuel basket 68 can be increased or decreased as necessary depending on the application, including, but not limited to, the fuel basket 68 having open space of around 30% to 40%, 20% to 40%, 40% to 50%, at least 20%, at least 30%, at least 40%, or at least 50%.

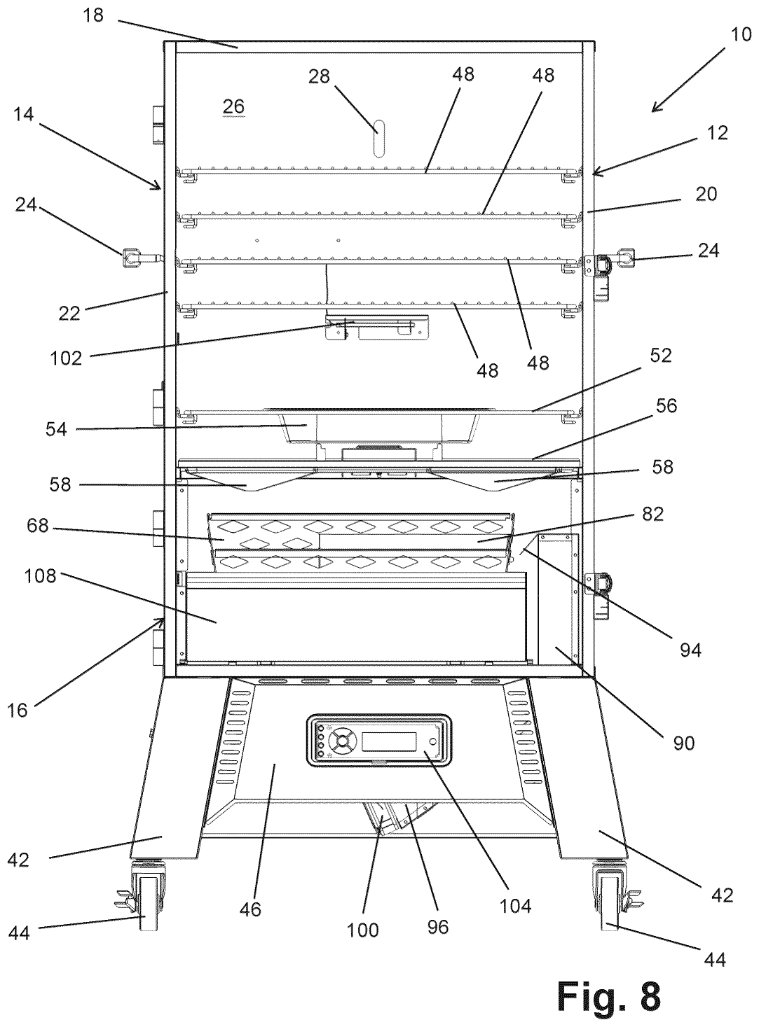

In an illustrative mode of operation shown in FIGS. 8-11 and 13A-16, an area or volume inside the fuel basket 68 may be divided into two sections by a substantially rectangular-shaped hollow divider 82, e.g., resulting in separate regions inside and outside the divider. The divider 82 has two solid sides preferably extending in a direction substantially parallel to the length of the fuel basket 68 and may slightly converge toward the right end 76 of the fuel basket 68. Thus, the shape of the divider 82 may be trapezoidal rather than perfectly rectangular. More generally, the divider 82 has solid ends, an open top, and an open bottom. Wood chunks or wood chips to add smoke flavor may be placed inside the interior region of the divider 82 and charcoal may be placed around the outside perimeter of the divider within the fuel basket 68.

While the shape of the divider 82 may be a quadrilateral, such as generally rectangular, square, or trapezoidal, those skilled in the art will appreciate that other divider shapes are also possible. For instance, in some embodiments, the divider 82 can comprise solid walls in the shape of any polygon or other shape, with an open top and open bottom, that defines separate regions where the user can place solid fuel in the fuel basket 68.

The fuel basket 68 with the divider 82 is nested inside an ash bowl 108 that catches the ashes from the charcoal or other fuel as it burns in the fuel basket 68 and passes through the openings 70 in the walls and bottom of the fuel basket 68. The ash bowl 108 with the nested fuel basket 68 can be removed as a single unit through the bottom door 38 of the lower fuel enclosure 16, for example, by positioning the ash bowl with nested fuel grate on a removable tray that a user can access through the bottom door 38.

In some embodiments, a water pan 54 may be mounted on a water pan rack 52 in the upper food-cooking enclosure 14 above the grease tray 56. The water pan 54 provides moisture to the food cooking in the upper food-cooking enclosure 14 so that the food will not dry out during extended cooking or smoking processes. In some embodiments, the water pan 54 may be seated in an opening of the water pan rack 52 or may be configured to hang down from the water pan rack 52, for example as FIGS. 8-10 show. Alternatively, the water pan 54 may be placed on a top surface of the water pan rack 52.

The grease tray 56 separates the upper food-cooking enclosure 14 from the lower fuel enclosure 16 of the cabinet 12. The grease tray 56 may include one or more grease tray bowls 58, each having a drain 60. The drains 60 are used to collect the grease drippings and direct them into the fire where the drippings are burned off. The grease tray 56 also includes one or more heat transfer openings 62 that allow heat and smoke from the lower fuel enclosure 16 to enter the upper food-cooking enclosure 14.

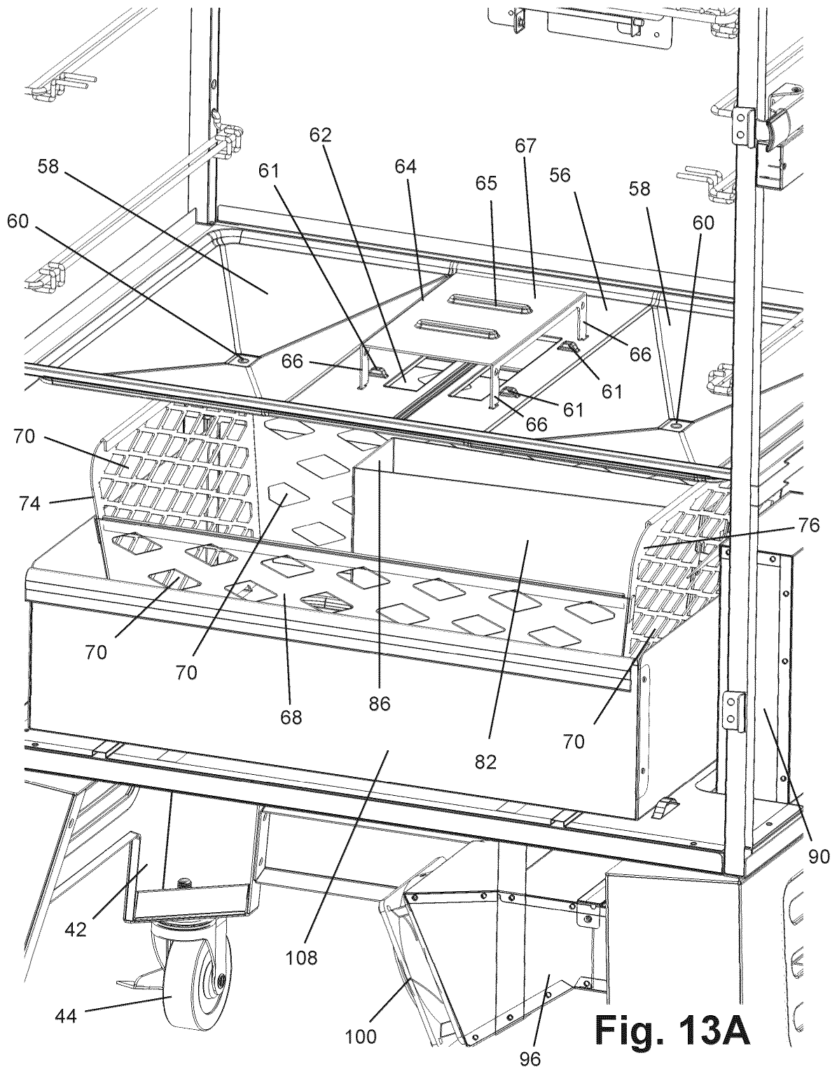

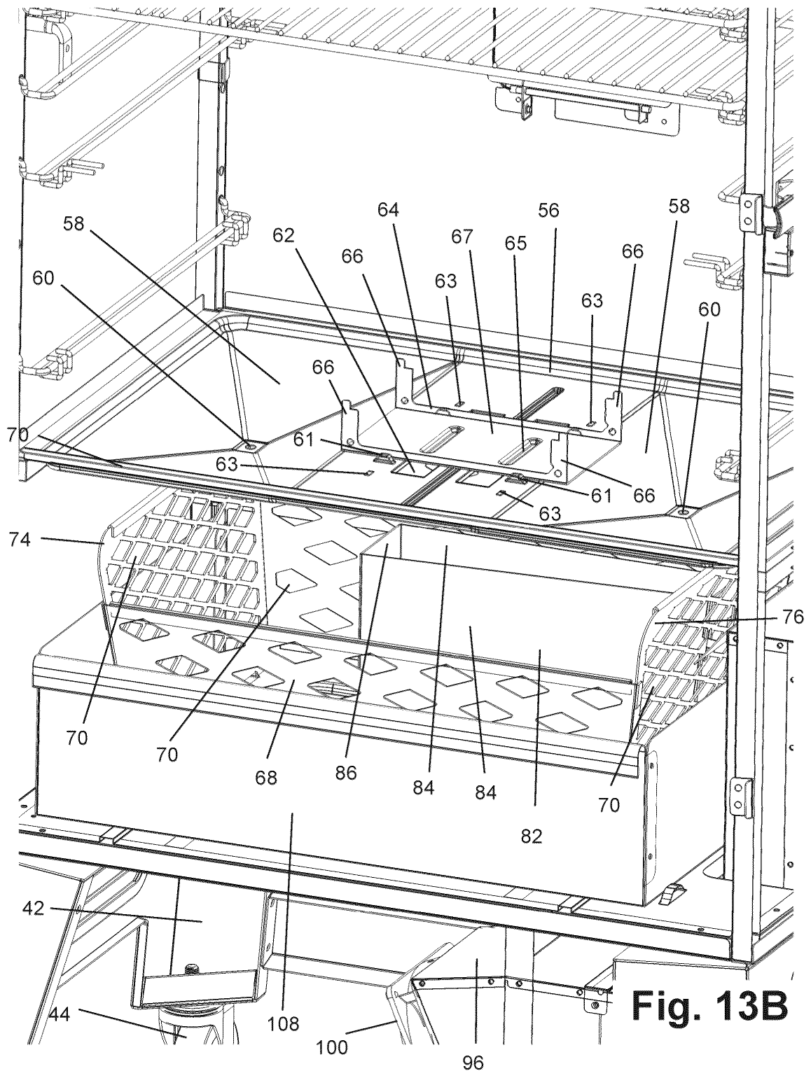

With reference to FIGS. 13A-16, air is supplied to the fuel basket 68 by a fan 100. In this exemplary embodiment, the fan 100 delivers air through an air duct or manifold 96 to an air column 90. The air column 90 has one or more air column openings 92 adjacent the right end 76 of the fuel basket 68. An air deflector 94 above the one or more air column openings 92 directs the air from the fan 100 downward toward the right end 76 of the fuel basket 68. In some embodiments, a flexible damper 98 may be positioned in the duct or manifold 96. The air pressure created by the fan 100 opens the damper 98 to allow air to flow through the manifold, to the air column 90, and out of the air column opening 92. At the end of the cooking process, the user may turn up the temperature on the control panel 104 to allow the fuel, such as charcoal, in the fuel basket 68 to burn out.

With reference to FIGS. 13A and 13B, a heat deflector tent 64 may be used to control the amount of heat and smoke that enters the upper food-cooking enclosure 14 through heat transfer openings 62 of the grease tray 56. In the exemplary embodiment, the heat deflector tent 64 has a base plate 67 with elongated dimples 65 and one or more legs 66. The grease tray 56 has slots 63 and blocks 61. In a low temperature mode, for example cooking or smoking below 275° F. (e.g., at approximately from 225° F. to 275° F.), the heat deflector tent 64 may be positioned as FIG. 13B shows. In this case, the heat deflector tent 64 may be positioned with its base plate 67 substantially flat on the grease tray 56 and legs 66 facing upward. In FIG. 13B, the blocks 61 on the grease tray 56 may engage the base plate 67 to restrict movement of the heat deflector tent 64 in a direction from front to back of the grill and smoker 10. The elongated dimples 65 in the base plate 67 may engage the sides of heat transfer openings 62 to restrict movement of the heat deflector tent 64 in a direction from side to side of the grill and smoker 10. When the heat deflector tent 64 is positioned as FIG. 13B shows, the amount of open area in the grease tray 56 for heat and smoke to pass from the lower fuel enclosure 16 into the upper food-cooking enclosure 14 may be approximately 2%.

In a higher temperature cooking mode, such as for example 275° F. and above, the heat deflector tent 64 may be positioned as FIG. 13A shows. In this configuration, the legs 66 of the heat deflector tent 64 engage the slots 63 in the grease tray 56, thereby elevating the base plate 67 of the heat deflector tent 64 above the heat transfer openings 62 and retaining the lateral position of the heat deflector tent 64. When the heat deflector tent 64 is positioned as shown in FIG. 13B, the amount of open area in the grease tray 56 between the upper food-cooking enclosure 14 and the lower fuel enclosure 16 may be approximately 4%.

The divided fuel basket described in the disclosed embodiments can allow for rough adjustment of the cooking or smoking temperature in the grill and smoker 10. For example, for temperatures at or above 275° F., a user may load up to 16 pounds of charcoal briquettes into the fuel basket 68. For cooking temperatures below 275° F., the user may load up to 12 pounds of charcoal briquettes loaded into the fuel grate 68.

Advantageously, the temperature inside the upper food-cooking enclosure 14 can be further controlled by the use of a combination of heat deflector tent 64 above the heat transfer openings 62 in the grease tray 56 and by varying the speed of the fan 100 to control the amount of combustion air supply to the fuel basket 68. Particularly, the grill and smoker 10 has a controller 106 that can control the speed of the fan 100. The controller 106 may receive a target temperature selected by the user on the control panel 104, and may also receive one or more signals indicating the temperature inside the upper food-cooking enclosure 14 from the temperature sensor 102 and/or additional temperature sensors inside the food-cooking enclosure. Based on the target temperature and a measured temperature inside the upper food-cooking enclosure 14, the controller 106 may adjust the speed of the fan accordingly to either lower or raise the temperature within limits inside the upper food-cooking enclosure 14. For example, if the controller 106 determines that the measured temperature is less than the target temperature by more than a first predetermined amount or percentage, then the controller may send one or more control signals to the fan or a fan controller to increase the speed of the fan or turn on the fan and thus increase the cooking or smoking temperature. Conversely, if the controller 106 determines that the measured temperature is above the target temperature by more than a second predetermined amount or percentage, the controller may send one or more control signals to the fan or a fan controller to decrease the speed of the fan or turn off the fan, to cause a decrease in the cooking or smoking temperature in the food-cooking enclosure 14. In some embodiments, the first predetermined amount or percentage and the second predetermined amount or percentage may be the same.

The top door 32 and/or the bottom door 38 may be coupled with at least one sensor (not shown) configured to generate a signal indicative of whether the door is open. The fan 100 may be configured to automatically turn on only if both of the top and bottom doors are closed. In some embodiments, the controller 106 may be configured to receive input signals from one or more sensors coupled to the top and bottom doors 32 and 38 to determine if both doors are closed before the controller 106 may send one or more digital or analog control signals to cause the fan 100 to turn on.

The following examples illustrate cooking with the exemplary grill and smoker 10 as described in the disclosed embodiments.

### Example 1

### For Cooking at Approximately 225° F.

1. Insert a charcoal grate divider 82 into the fuel basket 68.

2. Place the heat deflector tent 64 in the position shown in FIG. 13B (e.g., resulting in the grease tray 56 having approximately 2% open areas for heat and smoke to pass).

3. Load wood chunks into the center of the charcoal divider 82 or directly into the fuel grate 68 for added smoke flavor.

4. Load up to 12 pounds of charcoal into the fuel basket 68.

5. Load one or more fire starters into the fuel basket 68, for example in a dedicated compartment or area of the fuel basket configured to hold the fire-starter material.

6. Load the nested ash bowl 108, fuel grate 68, and divider 82 into the grill and smoker 10 through the bottom door 38.

7. After loading food onto cooking racks and/or hooks in the upper food-cooking enclosure 14, close the top door 32 of the grill and smoker 10.

8. Light the fire starters and carefully push the ash bowl 108 into the lower fuel enclosure 16 of the grill and smoker 10.

9. Leave the bottom door 38 open until the fire starters have caught fire, for example waiting for around three minutes.

10. After the fire starters are fully ignited, shut the bottom door 38.

11. Set temperature to 225° F. on the control panel 104.

12. Allow the grill and smoker 10 to preheat to the set temperature.

13. When cooking is complete, set the temperature to 400° F. and allow the wood and charcoal fuel loaded in the fuel basket 68 to burn out.

### Example 2

### For Cooking Between Approximately 230° F. and 270° F.

1. Insert a charcoal grate divider 82 into the fuel grate 68.

2. Place the heat deflector tent 64 in the position shown in FIG. 13A (e.g., resulting in the grease tray 56 having approximately 4% open areas for heat and smoke to pass).

3. Load wood chunks into the center of the charcoal divider 82 or directly into the fuel grate 68 for added smoke flavor.

4. Load up to 12 pounds of charcoal into the fuel basket 68.

5. Load one or more fire starters into the fuel basket 68, for example in a dedicated compartment or area of the fuel basket configured to hold the fire-starter material.

6. Load the nested ash bowl 108, fuel grate 68, and divider 82 into the grill and smoker 10 through the bottom door 38.

7. After loading food onto cooking racks and/or hooks in the upper food-cooking enclosure 14, close the top door 32 of the grill and smoker 10.

8. Light the fire starters and carefully push the ash bowl 108 into the lower fuel enclosure 16 of the grill and smoker 10.

9. Leave the bottom door 38 open until the fire starters have caught fire, for example waiting for around three minutes.

10. After the fire starters are fully ignited, shut the bottom door 38.

11. Set temperature to a temperature between 230° F. to 270° F. on the control panel 104.

12. Allow the grill and smoker 10 to preheat to the set temperature.

13. When cooking is complete, set the temperature to 400° F. and allow the wood and charcoal fuel loaded in the fuel basket 68 to burn out.

### Example 3

### For Cooking Approximately 275° F. and Above

1. Do not use a charcoal grate divider 82.

2. Place the heat deflector tent 64 in the position shown in FIG. 13A (e.g., resulting in the grease tray 56 having approximately 4% open areas for heat and smoke to pass).

3. Load up to 16 pounds of charcoal into the fuel basket 68.

4. Load one or more fire starters into the fuel basket 68, for example in a dedicated compartment or area of the fuel basket configured to hold the fire-starter material.

5. Load the nested ash bowl 108 and nested fuel basket 68 into the grill and smoker 10 through the bottom door 38.

6. After loading food onto cooking racks and/or hooks in the upper food-cooking enclosure 14, close the top door 32 of the grill and smoker 10.

7. Light the fire starters and carefully push the ash bowl 108 into the lower fuel enclosure 16 of the grill and smoker 10.

8. Leave the bottom door 38 open until the fire starters have caught fire, for example waiting for around three minutes.

9. After the fire starters are fully ignited, shut the bottom door 38.

10. Set temperature to 275° F. or above on the control panel 104.

11. Allow the grill and smoker 10 to preheat to the set temperature.

12. When cooking is complete, set the temperature to 400° F. and allow the charcoal fuel loaded in the fuel basket 68 to burn out.

### Other Operational Features of the Grill and Smoker 10

1. The grill and smoker 10 may have a temperature range from 225° F. to 400° F.

2. The controller 106 may be configured to control the fan speed so that the grill and smoker 10 does not get cooler during a cooking or smoking process. For example, if the temperature is set to 300° F. and the grill and smoker 10 is allowed to preheat, the controller 106 will not allow the temperature to be lowered to 225° F. during the cooking or smoking process.

3. In some embodiments if a charcoal grate divider 82 is inserted into the fuel basket 68, the upper food-cooking enclosure 14 may not reach a temperature above 275° F.

4. For faster preheat time, the user may allow the grill and smoker 10 to preheat without the heat deflector tent 64 installed. In such embodiments, once the upper food-cooking enclosure 14 reaches the set temperature, the user may insert the heat deflector tent 64 in the location and a configuration as described in the examples above.

In the disclosed embodiments, the controller 106 (which also may be referred to as control unit 106) may comprise one or more physical processors, such as a microprocessor, microcontroller, digital signal processor, field programmable gate array, application specific integrated circuit, or the like, and may further include at least one non-transitory memory device for storing associated software or firmware, configured to control at least some operations of the one or more physical processors in accordance with the disclosed embodiments described herein. The controller 106 also comprises a plurality of input/output (“I/O”) connections, for example interconnected with the one or more physical processors by a system bus, for communicating with other components in the temperature controlled charcoal grill and smoker 10. The controller 106 may, among other things, receive various user inputs and sensor signals and transmit control signals to the fan 100, or a separate fan controller (not shown) coupled to the fan 100, and other components in accordance with the disclosed embodiments described herein.

More generally, the controller 106 may be configured to control the fan speed, and thus the temperature inside the food-cooking enclosure, using any known control technique, including but not limited to closed-loop control using one or more temperature-measurement signals, e.g., from the temperature sensor 102. The controller 106 may include at least one processor and a memory that stores computer-executable instructions that, when executed by the at least one processor, comprises a software program that implements an appropriate control algorithm based on various sensor measurements received by the controller 106, such as from one or more ambient-air temperature sensors and/or meat-probe temperature sensors.

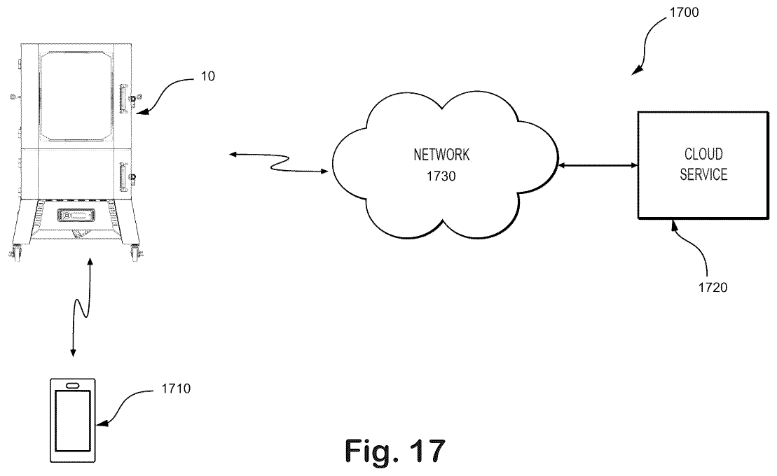

In some embodiments, the controller 106 also may have additional functions, such as receiving user input from the control panel 104 and/or communicating with a remote user device or remote computer as discussed further below with reference to FIG. 17. The controller 106 may include a display (not shown) for displaying temperature measurements or other information to the user. In some embodiments, the display may be a touch screen through which the user can input information, such as a target temperature.

The controller 106 preferably comprises at least one wireless transceiver configured to wirelessly communicate with one or more remote devices using any conventional wireless protocols, such as Bluetooth, ZigBee, or other protocols known in the art. The controller 106 also may include a wireless transceiver configured to communicate with over an IEEE 802.11 (“Wi-Fi”) network, a cellular network, or any other wireless network. Those skilled in the art will appreciate each wireless transceiver in the controller 106 is coupled to one or more respective antennas and other transmitter and receiver circuitry required to effect wireless communications. In some embodiments, the at least one wireless transceiver may be further configured to wirelessly communicate with the fan 100 or a fan controller (not shown) coupled to the fan 100. In some embodiments, the controller 106 also may be connected over wired connections to one or more sensors (e.g., one or more meat probes or temperature sensors), the fan 100, or other components in the grill and smoker 10, depending on the controller's relative proximity to those components.

FIG. 17 is a schematic diagram illustrating an exemplary network architecture 1700 in which the grill and smoker 10 may be configured to wirelessly communicate with a user device 1710 and also may be configured to wirelessly communicate via a network 1730 with one or more remote computers that provide a cloud service 1720 in a cloud computing platform in accordance with certain disclosed embodiments. For example, the user may have a mobile device, such as a smartphone, tablet, laptop, or other user equipment, or another type of remote device, such as a desktop or appliance, that can establish a wireless connection with the controller 106. The user device 1710 may be configured to communicate with the controller 106 over a peer-to-peer wireless connection, such as over a Bluetooth connection, or over a local area network, such as a Wi-Fi network.

The controller 106 also may establish a network connection with one or more remote servers through a network 1730, which may be a public network such as the Internet. For example, the controller 106 may be configured to communicate packet-based information with one or more remote servers using Internet protocols, such as HTTP and TCP/IP. In some embodiments, the controller 106 preferably accesses at least one cloud-based service 1720 on the one or more remote servers through the network 1730. The cloud-based service 1720 may provide certain database services for managing data collected by sensors in the grill and smoker 10 and other information generated or collected by the controller 106 or other components in the grill and smoker 10. In addition, the cloud-based service 1720 may provide data, commands, and/or instructions to the controller 106, for example, that may be used by the control unit to implement a strategy for controlling an amount of air flow in the upper food-cooking enclosure 14 by controlling a speed of the fan 100.

In some embodiments, the controller 106 may be configured to receive user inputs from the user device 1710 rather than from the control panel 104. For example, the user device 1710 may execute an application that provides a user interface which allows the user to input selections, for example, for setting a target temperature inside the food-cooking enclosure 14. The user device 1710 may be configured to transmit such user inputs over the wireless connection to the controller 106, which processes the received user inputs in the same way as it would if they had been received directly from user-interface elements on the control panel 104. For example, the user may select a target temperature for the food-cooking enclosure using the application on the user device 1710, then the user device 1710 may send the user's selected target temperature to the controller 106 over a Bluetooth connection or a Wi-Fi network.

Those skilled in the art will also appreciate that other modifications and alternatives may be implemented in accordance with the exemplary embodiments described herein. For example, the controller 106 may have other functionality in addition to those exemplary processes and components described herein. For instance, it will be apparent to those skilled in the art that various processor and memory types, including various computer-readable media, may be used, for example to implement the controller 106 and/or control panel 104, to store and execute program instructions pertaining to the techniques described herein. In other embodiments, the controller 106 may be responsive to touch or voice commands, or receive instructions through an integrated cloud-based voice program (e.g., Amazon Alexa, Google Assistant, Microsoft Cortana, or Apple Siri).

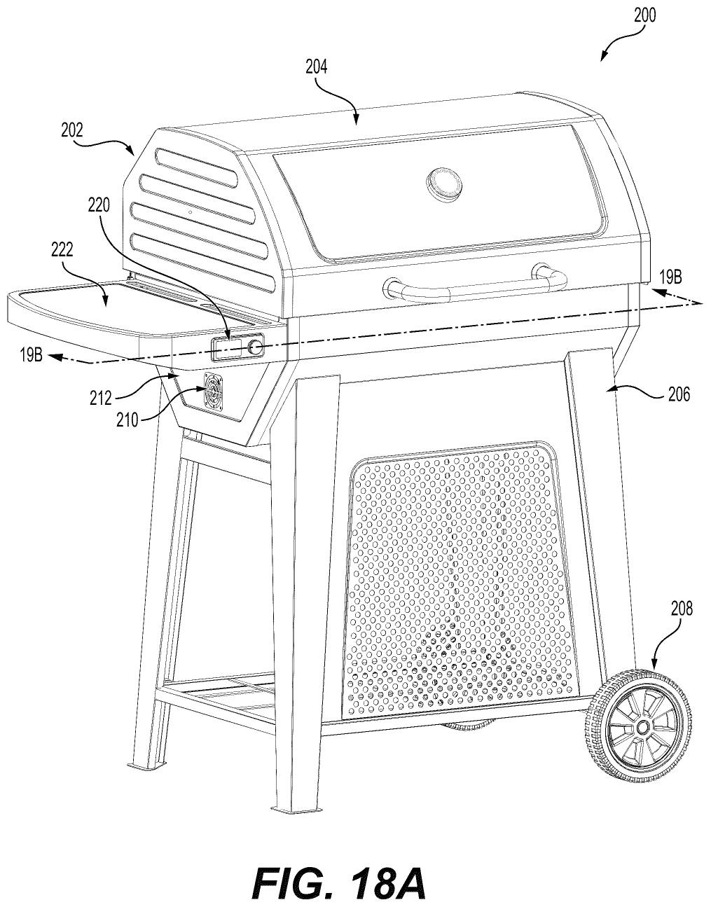

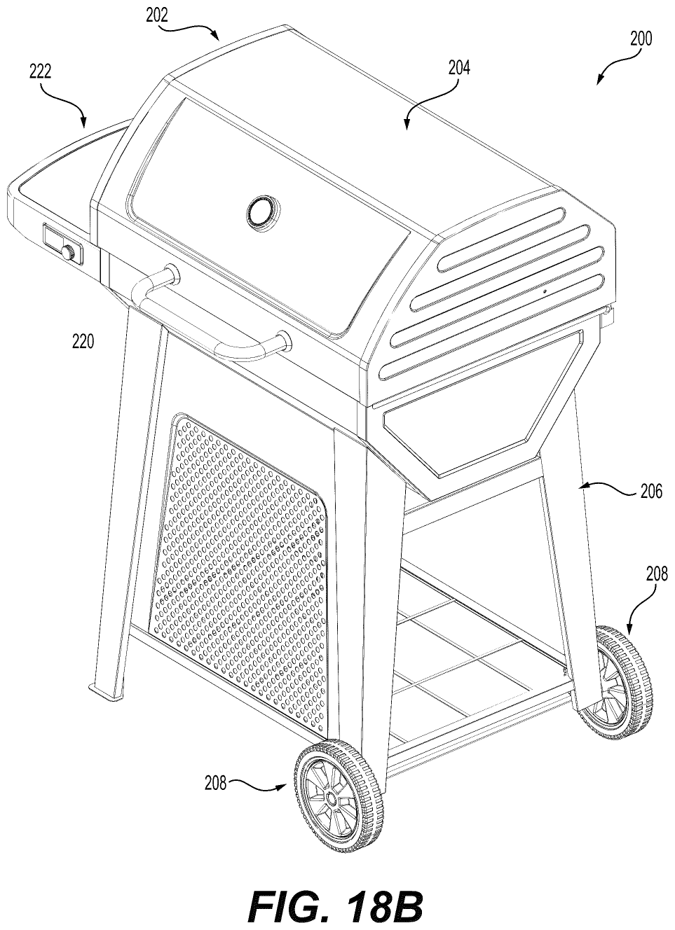

FIG. 18A-FIG. 23 illustrate a second embodiment of a temperature-controlled grill and smoker 200, in accordance with the disclosed embodiments of the invention. Temperature controlled charcoal grill and smoker 200 may comprise some or all of the elements described above in association with FIGS. 1-17, which illustrate temperature controlled charcoal grill and smoker 10.

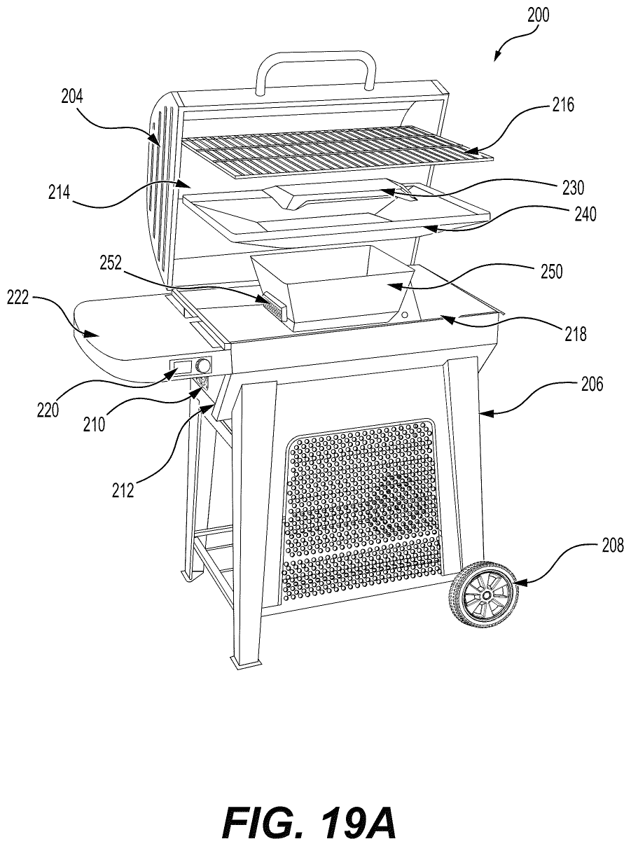

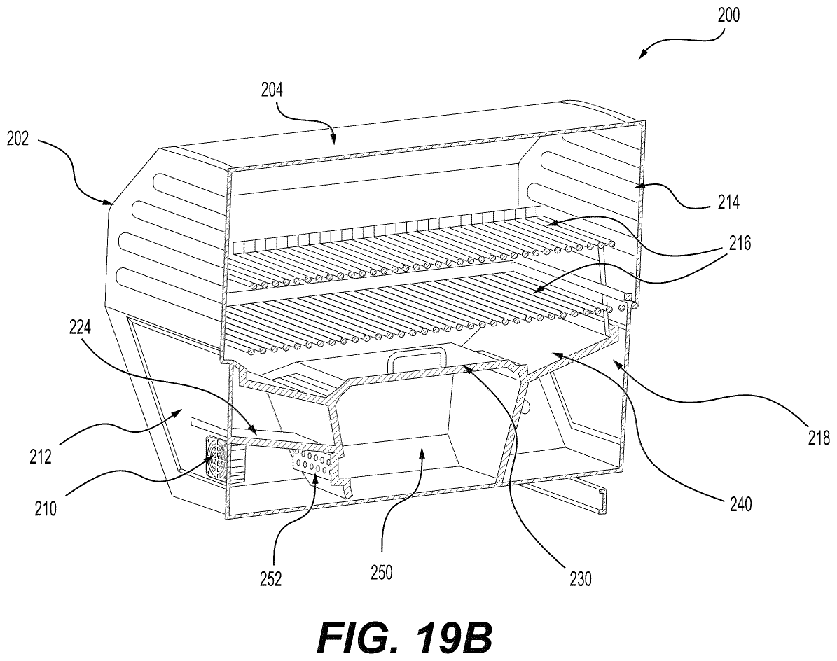

As illustrated in FIGS. 18A and 18B, temperature controlled charcoal grill and smoker 200 comprises a food-cooking enclosure 202 mounted on a cart 206. Food-cooking enclosure 202 comprises a lid 204 that can be opened (as shown in FIGS. 19A-19B) to reveal the interior of the food-cooking enclosure. In some embodiments, as illustrated in FIGS. 18A and 18B, cart 206 comprises two or more wheels 208 that can be used to transport temperature controlled grill and smoker 200. Cart may also comprise a side shelf 222.

Temperature controlled charcoal grill and smoker 200 comprises a fan 210 positioned in a side wall 212 of food-cooking enclosure 202 and a controller 220 electrically coupled to the fan 210. In some embodiments, as illustrated in FIGS. 18A and 18B, controller 220 may be mounted in side shelf 222 of cart 206. Controller 220 may have one or more of the features discussed above with respect to controller 106 and may similarly be used to control the speed of the fan 210 to adjust and/or control a temperature within the food-cooking enclosure 202.

FIG. 19A and 19B illustrates temperature-controlled charcoal grill and smoker 200 with lid 204 in an open configuration. Food-cooking enclosure 202 can generally comprise an upper food cooking area 214 comprising one or more cooking racks 216 for holding food to be cooked. The one or more cooking racks 216 can be positioned vertically, one above the other, within food cooking area 214 and above a lower area 218 of the food-cooking enclosure 202. Lower area 218 of food-cooking enclosure 202 can house a plurality of internal components including a heat deflector tent 230, a grease tray 240, and a fuel basket 250. As illustrated in FIG. 19B, heat deflector tent 230 can be positioned at a distance below one or more cooking racks 216, grease tray 240 can be positioned below heat deflector tent 230 (or as discussed below, heat deflector tent 230 can be mounted on grease tray 240), and fuel basket 250 can be positioned below grease tray 240. As such, grease tray can capture and funnel grease into fuel basket 250 and heat deflector tent 230 can prevent grease flareups from the burning fuel in the fuel basket 250. Fuel basket 250 can also comprise an air inlet 252, which is positioned to receive a flow of air from fan 210 and deliver the flow of air into fuel basket 250 (e.g., to fuel combusting within fuel basket 250). In some embodiments, as illustrated in FIG. 19B, air inlet 252 may be horizontally aligned with fan 210. An air tunnel wall 224 can be positioned above fan 210 and air inlet 252 and below grease tray 240. Together with a bottom surface of cooking enclosure 202, air tunnel wall 224 may create a tunnel for directing airflow to air inlet 252.

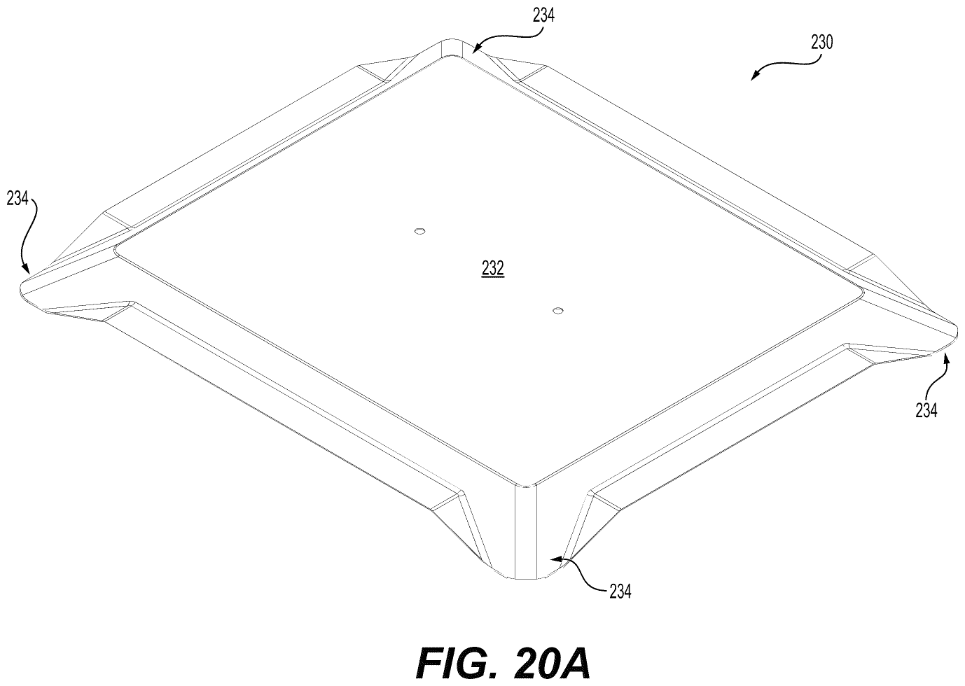

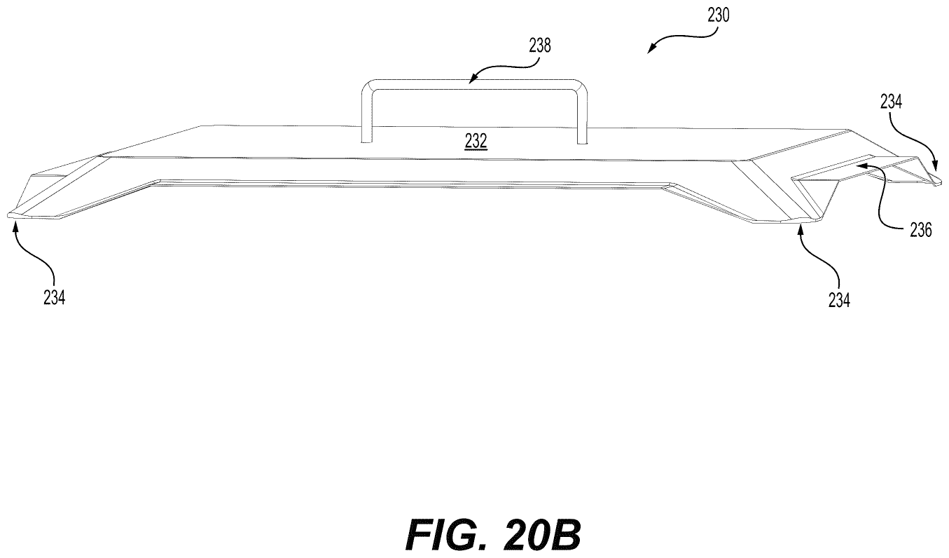

FIGS. 20A and 20B illustrate an exemplary heat deflector tent 230 that may be used in temperature-controlled charcoal grill and smoker 200, for instance, to prevent flareups from fuel burning in fuel basket 250. Heat deflector tent 230 comprises a top surface 232. As illustrated in FIGS. 20A and 20B, top surface 232 may be flat and rectangular shaped although it is understood that, in other embodiments, top surface 232 may be any shape and inclined or only partially flat. In other embodiments, top surface 232 may be v-shaped such that heat deflector tent 230 resembles a tent. Heat deflector tent 230 also comprises one or more legs 234 extending downwardly from top surface 232. As illustrated in FIG. 20B, one or more legs 234 may be sloped downwardly from top surface 232. In some embodiments, one or more legs 232 may be sloped downwardly at a 90-degree angle or perpendicularly with respect to top surface 232. In other embodiments, one or more legs 232 may be sloped at an angle less than 90-degrees with respect to top surface 232, as illustrated in FIGS. 20A and 20B. Heat deflector tent 230 may also comprise one or more heat-deflection portions 236 for deflecting and delivering heat out of one or more of the sides of the heat deflector tent 230 to food cooking on the cooking racks 216 positioned above the heat deflector tent 230. Heat deflector tent 230 may also comprise a handle 238 to assist with removing and re-inserting the heat deflector tent 230 from the temperature controlled grill and smoker 200.

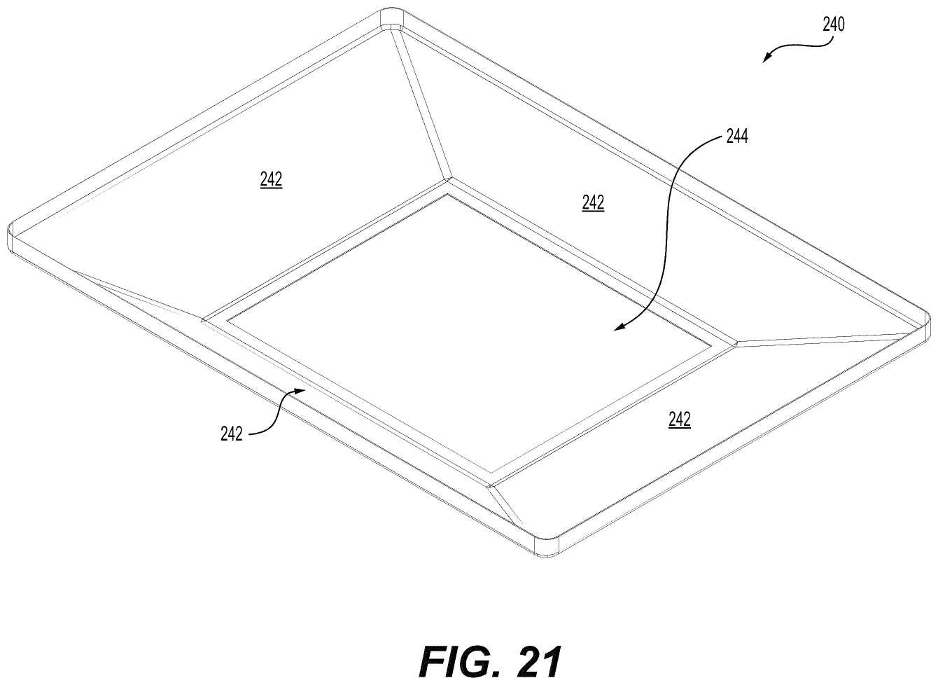

FIG. 21 illustrates an exemplary grease tray 240. Grease tray 240 comprises one or more inclined surfaces or walls 242 and an opening 244 for depositing grease into fuel basket 250.

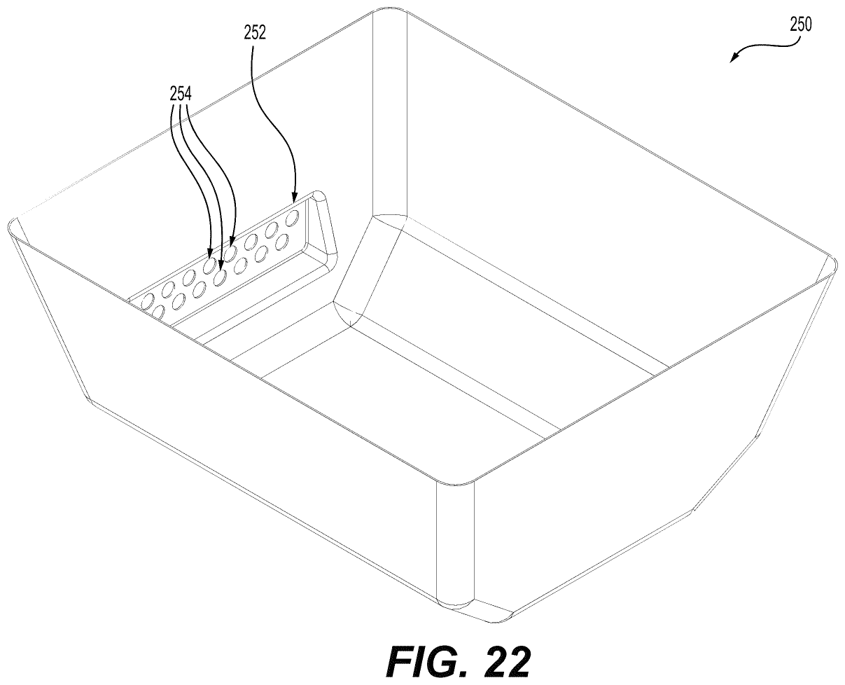

FIG. 22 illustrates an exemplary fuel basket 250. Fuel basket 250 is configured to hold fuel to burn and create heat during cooking. Fuel basket 250 comprises an air inlet 252 comprising one or more air-intake holes 254 for receiving airflow from fan 210. In other embodiments, fuel basket 250 can comprise one or more features discussed above with respect to fuel basket 68.

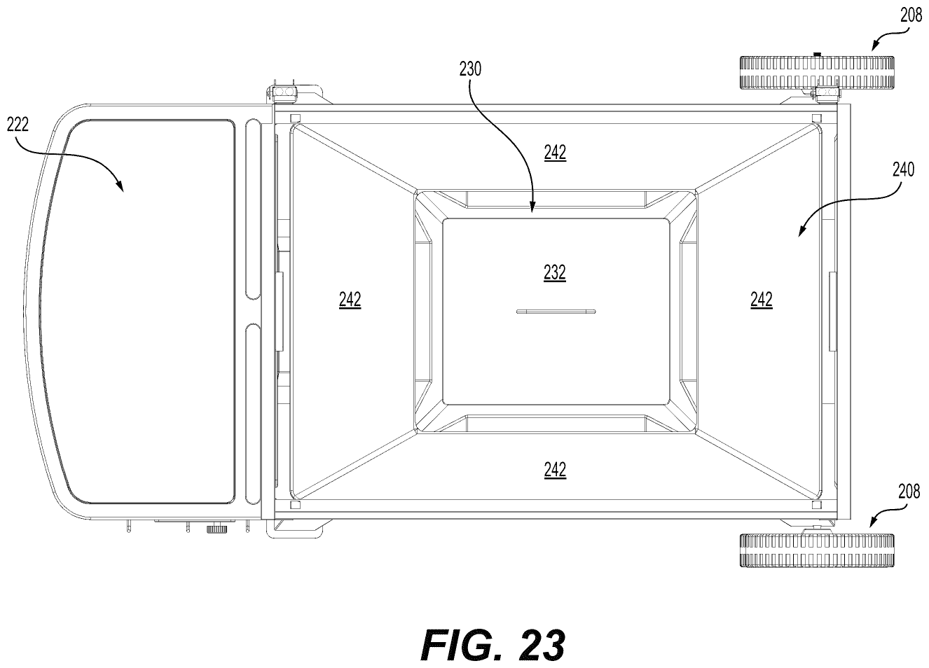

As illustrated in FIG. 23, heat deflector tent 230, grease tray 240, and fuel basket 250 can be positioned within lower area 218 of food-cooking enclosure 202. In some embodiments, grease tray 240 can be removably positioned or mounted within lower area 218 so it can be removed and cleaned. As illustrated in FIGS., heat deflector tent 230 can be mounted above opening 244 of grease tray 240. For instance, one or more legs 232 of heat deflector tent 230 can rest on the one or more inclined surfaces 242 of grease tray 240. In another embodiment, one or more legs 232 of heat deflector tent 230 can rest on charcoal basket 250.

The following example illustrates cooking with the exemplary temperature controlled grill and smoker 200 as described in the disclosed embodiments.

### Example 4

1. Load charcoal into the fuel basket 250.

2. Load one or more fire starters into the fuel basket 250 and light.

3. Place the heat deflector tent 230 in the position shown in FIGS. 19B and FIG. 23 on top of fuel basket 250

4. Leave the lid 204 open until the fire starters have caught fire, for example waiting for around three minutes.

5. After the fire starters are fully ignited, shut the lid 204.

6. Set temperature to 275° F. or above on the control panel 220.

7. Allow the grill and smoker 200 to preheat to the set temperature.

8. Place food on grill racks 216 for cooking.

### Other Operational Features of Temperature Controlled Grill and Smoker 200

1. The grill and smoker 200 may have a temperature range from 225° F. to 700° F.

2. The controller 220 may be configured to control the fan speed so that the grill and smoker 200, such as for instance if different temperatures are required during a cook.

3. For faster preheat time, the user may allow the grill and smoker 200 to preheat without the heat deflector tent 240 installed. In such embodiments, once the upper food-cooking enclosure 214 reaches the set temperature, the user may insert the heat deflector tent 230 in the location and a configuration as described in the examples above.

While this invention has been described with reference to preferred embodiments thereof, it is to be understood that variations and modifications can be affected within the spirit and scope of the invention as described herein and as described in the appended claims. Accordingly, this description is to be taken only by way of example and not to otherwise limit the scope of the exemplary disclosed embodiments herein. Therefore, it is the object of the appended claims to cover all such variations and modifications as come within the true spirit and scope of the embodiments disclosed herein.

We claim:

1. A temperature-controlled grill and smoker, comprising:
a cooking rack for holding a food product;
a fuel basket configured to hold one or more types of solid fuel, the fuel basket having an air inlet that allows air to pass into the fuel basket to the one or more types of solid fuel;
a grease tray located below the cooking rack and above the fuel basket the grease tray including an opening located above the fuel basket that allows smoke and heat generated from solid fuel in the fuel basket to reach the food product on the cooking rack;
a heat deflector tent positioned above the opening in the grease tray; and
a fan configured to selectively provide air through the air inlet and into the fuel basket.

2. The temperature-controlled grill and smoker of claim 1 further comprising a food-cooking enclosure comprising a cooking area housing the cooking rack and a lower area housing the heat deflector tent, the grease tray, and the fuel basket.

3. The temperature-controlled grill and smoker of claim 1, wherein the heat deflector tent is configured to be mounted above the opening in the tray by covering at least a portion of the opening in the tray.

4. The temperature-controlled grill and smoker of claim 3, wherein the heat deflector tent comprises a top surface and one or more legs sloped downwardly from the top surface, wherein the one or more legs mount the top surface over at least a portion of the opening in the tray.

5. The temperature-controlled grill and smoker of claim 4, wherein the top surface of the heat deflector tent is configured to block flames generated by the solid fuel in the fuel basket from reaching the cooking rack.

6. The temperature-controlled grill and smoker of claim 1, wherein the heat tent is removable.

7. The temperature-controlled grill and smoker of claim 2, wherein the fan is mounted in a side wall of the food-cooking enclosure.

8. The temperature-controlled grill and smoker of claim 6, further comprising an air tunnel wall positioned above fan and the air inlet of the fuel basket.

9. The temperature-controlled grill and smoker of claim 1, further comprising a controller configured to cause the fan to deliver air to the air inlet of fuel basket.

10. The temperature-controlled grill and smoker of claim 9, wherein the controller is configured to determine a speed of the fan based on a target temperature input by a user through one or more user-interface elements on a control panel coupled to the controller.

11. The temperature-controlled grill and smoker of claim 1, wherein controller is configured to determine a speed of the fan based on a target temperature received from a remote user device over a wireless connection.
